(19) United States
(12) Patent Application Publication
(10) Pub. No.: US 2018/0032891 A1
(43) Pub. Date: Feb. 1, 2018

(54) ADAPTIVE ARCHITECTURE FOR CRASH PREDICTION IN VEHICLE COLLISION AVOIDANCE SYSTEMS

(71) Applicant: INTERNATIONAL BUSINESS MACHINES CORPORATION, ARMONK, NY (US)

(72) Inventors: YUTAO BA, Beijing (CN); Miao He, Beijing (CN); Wei Lin, Beijing (CN); Qinhua Wang, Beijing (CN); Zongying Zhang, Beijing (CN)

(21) Appl. No.: 15/223,601

(22) Filed: Jul. 29, 2016

(51) Int. Cl. G06N 7/00

(52) U.S. Cl. CPC G06N 7/005

(57) ABSTRACT

Real-time collision avoidance in moving vehicles includes initializing a prior collision distribution from a manufacturer's vehicle calibration, receiving driver data acquired from a driver when a vehicle is driven and vehicular data acquired from the vehicle being driven by the driver, determining a conditional collision probability using features derived from the driver data and the vehicular data and a model for the driver, calculating posterior probability collision distribution from the conditional collision probability and the prior collision distribution, and determining a probability of a collision occurring from the posterior probability collision.

### BACKGROUND

### Technical Field

Embodiments of the present disclosure are directed to an adaptive architecture for a real-time crash prediction system with increased predictive accuracy and predictability.

### Discussion of the Related Art

Traffic accidents present major global social issues. Each year, there are 1.3 million deaths and 50+ million injuries caused by traffic accidents. In response, vehicle collision avoidance systems (VCASs) have been developed that can detect and avoid an impending collision. The fundamental technology underlying collision avoidance systems and other active safety systems is the real-time collision prediction. After a prediction, a VCAS either provides warnings or takes interventions autonomously.

Prior art methods of collision prediction are based on distance metrics and vehicle dynamics. A vehicle manufacturer will provide an initial calibration for a VCAS. Current collision avoidance technology is based on a static model provided by vehicle manufacturer, which is usually a pre-defined threshold for prediction. For example, a binary classifier may use a critical threshold based on an analytical model, e.g., Critical threshold=f(distances+vehicle dynamics). When a driver begins driving, the VCAS begins recording data, including the distance traveled and the vehicle dynamics. If a current value<critical threshold, then the VCAS predicts that a collision will occur, and issues a warning to the driver to take action, otherwise the VCAS may either do nothing or issue a notification of a low risk situation. The analytical model f(x) is defined by each automobile manufacturer as part of the initial calibration. A crash may or may not occur.

However, prior art models suffer from low accuracy and low predictability. Prior art VCASs have an open loop structure that is based on the manufacturer's calibration which cannot be adapted to different drivers, and yield a prediction only within a critical situation. To address accuracy, i.e., to decrease the misses, a VCAS should increase the false positive rate. However, these false positives can distract a driver and cause undue stress, and further cause the driver to mistrust the VCAS. In addition, VCASs do not provide warning or intervention until the situations have become very urgent, usually less than 5 s before collision. This requires a drivers' fast perception and response. For example, let f(vehicle=‘Mfg. name’, speed=40 km/h, relative velocity=30 km/h)≈15 m. Then the reaction time=15 m/30 km/h=1.8 s. Is 1.8 s enough time for a driver to avoid a collision?

Why do current VCASs have low accuracy and predictability? One reason is that current systems predict systematic risk with an open-loop system. However, with drivers, the whole system is actually a closed-loop. In addition, current VCAS inputs include only distance metrics and vehicle dynamics. However, this data is insufficient to estimate a crash probability before a critical situation, such as one involving a short distance and high velocity. Finally, there are limitations to the manufacturer's calibration. Although a manufacturer can know a vehicle's initial state, the manufacturer cannot predict each individual vehicle's situational responses.

The prior art have focused on several points: (1) the design or modification of the hardware and software of traditional crash prediction methods; (2) measuring drivers' physiological and mental states related to crash involvements; and (3) intuitive frameworks for combining driver state monitoring with the real-time crash prediction. Studies have proposed the intuitive concepts of including the human state as a factor, and others have proposed a flexible and practical approach with validated testing results. Thus, there is a need for more precise collision prediction for advanced VCAS, as well as a next generation of intelligent vehicles.

### SUMMARY

Exemplary embodiments of the present disclosure provide an adaptive architecture and method to predict a collision using a drivers' individual and situational data to adjust the manufacturer-calibrated model. Performance of a prediction method according to an embodiment has been validated via a large sample size experiment, whose results confirm that, with a longer prediction time (>4 s), the accuracy significantly increased and the false alarm rate significantly decreased.

According to an embodiment of the disclosure, there is provided a method for real-time collision avoidance in moving vehicles, including initializing a prior collision distribution from a manufacturer's vehicle calibration, receiving driver data acquired from a driver when a vehicle is driven and vehicular data acquired from the vehicle being driven by the driver and a model for a driver, determining a conditional collision probability using features derived from the driver data and the vehicular data, calculating posterior probability collision distribution from the conditional collision probability and the prior collision distribution, and determining a probability of a collision from the posterior probability collision.

According to a further embodiment of the disclosure, driver data and vehicular data is continuously acquired from the driver and vehicle while the vehicle is in motion.

According to a further embodiment of the disclosure, the driver data includes one or more of demographic data, driving history data, and behavioral and physiological data.

According to a further embodiment of the disclosure, the vehicular data includes distance to detected risk (DDR), time to collision (TTC), speed, gas-pedal, brake-pedal, and steering-wheel.

According to a further embodiment of the disclosure, features extracted from the driver data and vehicular data include one or more of mean values, standard deviations, minimum values and maximum values, and on-road time percentages.

According to a further embodiment of the disclosure, driver data and vehicular data is combined into a single dataset synchronized by time of acquisition.

According to a further embodiment of the disclosure, the method includes, determining that a probability of collision is high, and issuing a warning to the driver or intervening in the driver's operation of the vehicle, in response to determining that a probability of collision is high.

According to a further embodiment of the disclosure, the method includes, updating the manufacturer's vehicle calibration based on posterior probability collision acquired from all drivers.

According to a further embodiment of the disclosure, the method includes using principle component analysis to reduce the number of features used to determine the conditional collision probability distribution.

According to another embodiment of the disclosure, there is provided a system for real-time collision avoidance in moving vehicles, including first sensors in a vehicle that acquire behavioral and physiological data from a driver, second sensors in the vehicle that acquire distance metrics and vehicle dynamics data from a vehicle in motion, a feature generator and combiner in the vehicle that receives the behavioral and physiological data from the first sensors and the distance metrics and vehicle dynamics data from the second sensors, combines the behavioral and physiological data and distance metrics and vehicle dynamics data into a combined dataset synchronized by acquisition time, and extracts features from the combined dataset, a classifier in the vehicle that receives features from the feature generator and combiner, uses the features to determine a conditional collision probability distribution, and combines the conditional collision probability distribution with a prior collision probability distribution to calculate the probability of a collision occurring, and a warning system in the vehicle that presents a visual or audible warning to the driver if a the probability of a collision is determined to exceed a predetermined threshold.

According to a further embodiment of the disclosure, the system includes a controller that takes control of the vehicle from the driver if a collision is determined to exceed a predetermined threshold.

According to a further embodiment of the disclosure, the prior collision probability distribution is based on a manufacturer's calibration of the vehicle, the conditional collision probability distribution includes demographic and driving history data of the driver, and the system further comprises a wireless network connection that transmits updates for the manufacturer's calibration of the vehicle.

According to another embodiment of the disclosure, there is provided a non-transitory program storage device readable by a computer, tangibly embodying a program of instructions executed by the computer to perform the method steps for real-time collision avoidance in moving vehicles.

### BRIEF DESCRIPTION OF THE DRAWINGS

FIG. 1A illustrates a fixation distribution plot, according to an embodiment of the disclosure.

FIG. 1B depicts a graph of skin conductance over time, according to an embodiment of the disclosure.

FIG. 2 is a flowchart of a crash avoidance algorithm according to an embodiment of the disclosure.

FIG. 3 is a schematic block diagram of a VCAS according to an embodiment of the disclosure.

FIG. 4 depicts a driving simulator according to an embodiment of the disclosure.

FIG. 5 is a table driving simulator results, according to an embodiment of the disclosure.

FIG. 6 is a schematic of an exemplary cloud computing node that implements an embodiment of the disclosure.

FIG. 7 shows an exemplary cloud computing environment according to embodiments of the disclosure.

### DETAILED DESCRIPTION OF EXEMPLARY EMBODIMENTS

Exemplary embodiments of the disclosure as described herein generally include an adaptive architecture for a real-time crash prediction system with increased predictive accuracy and predictability. Embodiments are described, and illustrated in the drawings, in terms of functional blocks, units or steps. Those skilled in the art will appreciate that these blocks, units or steps can be physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units or steps being implemented by microprocessors or similar, they may be programmed using software, such as microcode, to perform various functions discussed herein and may optionally be driven by firmware and/or software. Alternatively, each block, unit or step may be implemented by dedicated hardware, or as a combination of dedicated hardware to perform some functions and a processor, such as one or more programmed microprocessors and associated circuitry, to perform other functions. Also, each block, unit or step of the embodiments may be physically separated into two or more interacting and discrete blocks, units or steps without departing from the scope of the disclosure. Further, the blocks, units or steps of the embodiments may be physically combined into more complex blocks, units or steps without departing from the scope of the disclose. Accordingly, while the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure. In addition, it is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Exemplary embodiments of the present disclosure provide an adaptive architecture to construct a VCAS which can increase the predictive accuracy, e.g. higher hit rate and lower false positive rate, and predictability, e.g. time duration prior to crash. According to embodiments of the disclosure, accuracy and predictability of a VCAS can be improved by incorporating known driver characteristics in a closed-loop: e.g., adjusted critical threshold=g(distance+vehicle dynamics+driver). A VCAS according to an embodiment uses Bayesian learning methods to ensure that an analytical prediction model learns parameters by continuously collecting data during daily driving. Thus, a VCAS according to an embodiment can update itself automatically after the manufacturer's calibration. The use of a prior and posterior probability can estimate a crash probability either when current value>=f(distance+vehicle) or current value<f(distance+vehicle). Bayesian learning methods can also ensure that the updated parameters differ across different driver individuals. Thus, each driver would have a unique model which considers the characteristics of the individual rather than the general population. In other words, gᵢ( )≠gⱼ( ), for i≠j, i, j=vehicle index. The inputs to the Bayesian learning methods include independent data flows from both the vehicle, such as distance and vehicle dynamics, and the driver's perception-cognition-behavior process, such as eye fixation, bio-signals, behavioral patterns, etc. Thus, a crash prediction is based on the systematic risk estimation of this close-loop, and can be provided before a situation becomes critical. In an architecture according to an embodiment, the original manufacturer's calibration can be used before learning, and different input combinations can be used during learning. Performance of a VCAS according to an embodiment can be improved by combining data from multiple vehicle sensors. Such software-level integration is compatible with a system design according to an embodiment, as well as other emerging technologies, such as driver's electroencephalogram recordings.

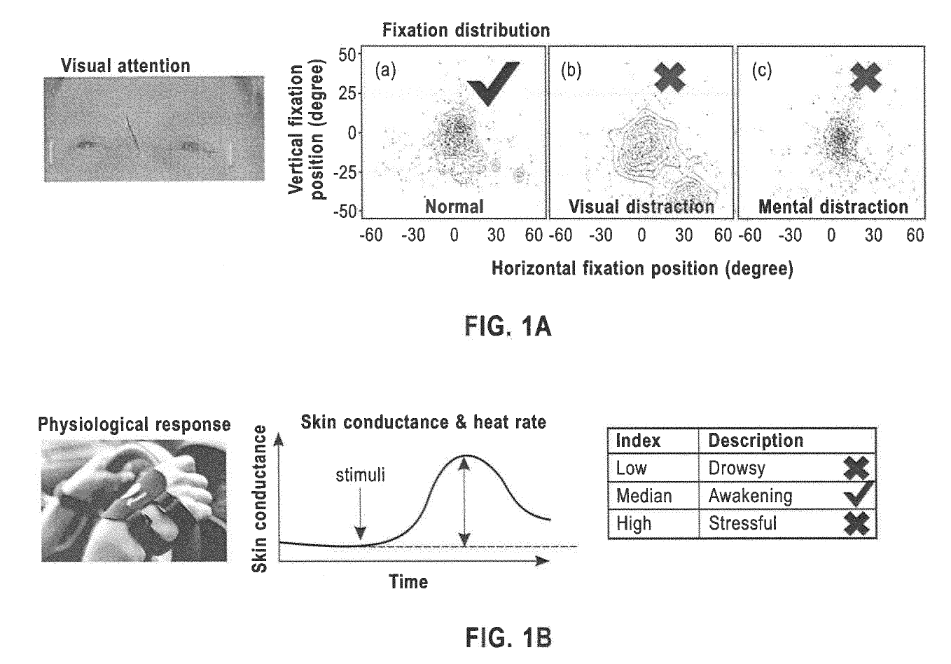

A VCAS according to an embodiment of the disclosure uses behavioral and physiological data to identify a driver's high risk states. A fixation distribution plot, as shown in FIG. 1A, which measures a driver's visual attention, helps to evaluate drivers' instantaneous capacity of visual perception. When a distribution shows that a high percentage of visual fixations occur in an off-road area, there is very high probability of visual distraction. In contrast, when a high percentage of visual fixations occur in a road area, however, the distribution is very concentrated, and there is high probability of mental distraction, i.e., the driver is looking but not seeing. Skin conductance and heart rate can be used to evaluate a driver's psychological states. When skin conductance or heart rate are high, a driver is in over-roused state, related to anger or anxious feelings. When skin conductance or heart rate are very low, a driver is in a sleepy state, related to lassitude. Both types of the above states are risky when driving. FIG. 1B depicts a graph of skin conductance over time, and shows a rise in response to a stimulus. These parameters and behavioral measures are used to train to a Bayesian classifier for a high accuracy prediction.

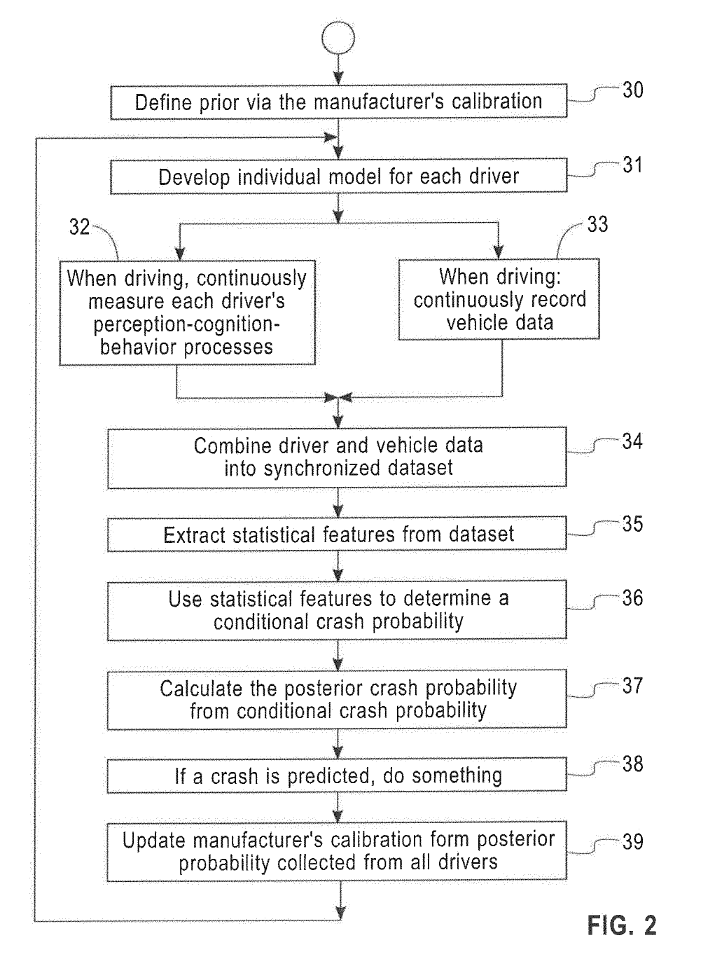

FIG. 2 is a flowchart of a crash avoidance algorithm according to an embodiment of the disclosure. Referring now to the figure, a method starts at step 30 by defining the initial prior probability of the Bayesian classifier via the manufacturer's calibration parameters to ensure that the initial prediction results are consistent with the original manufacturer's model. For each driver, at step 31, an individual model is developed according to the driver's personal profile, which includes characteristics such as gender, age, education, driving age, annual distance driven, etc. According to embodiments, the individual driver's model is incorporated into the conditional probability, as described below. When a driver is actually driving his/her vehicle, each driver's perception-cognition-behavior processes are continuously measured, at step 32. The measurements include data regarding eye fixation, bio-signals, behavioral patterns, etc. In addition, vehicle data is continuously acquired at step 33, including distance traveled and dynamical data, such as current speed and average speed. The driver and vehicle data are periodically combined into a single dataset at step 34, synchronized by time of acquisition, and features are extracted from this dataset at step 35.

A VCAS according to an embodiment of the disclosure uses a Bayesian classifier with a prior probability and a conditional probability to calculate a posterior probability of a crash. A prior probability,

$$P ( {G}_{i} = k ) = \frac{{n}_{k}}{n} ,$$

is based on the manufacturer's calibration model. Here, Gᵢ refers to the set of occurrences, either crash or no_crash, for a set of data points i, k is the number of classes, which according to embodiments, is 2, for either a crash or no_crash, nₖ is the number of events of class k and n is a total number of events of all classes, i.e., both crash and no_crash. Then, the features are extracted from driver and vehicle dataset can be provided to a trained discriminant model to predict whether or not a crash will occur. Let cᵢ be a vector that represents the set of statistical features, μₖ be a vector that represents the mean value of training set associated with class k, and Σₖ be the covariance matrix of the training set associated with class k. Then a crash will be predicted if a log-likelihood ratio of the discriminant model gₖ(cᵢ) for the two cases is greater than a predetermined threshold: gₖ₌₁(cᵢ)−gₖ₌₀(cᵢ)>T, where k=1 indicates a crash, and k=0 indicates no_crash. According to embodiments, the number of features used in the models can be reduced using principle component analysis (PCA). According to embodiments, gₖ(cᵢ) may be a linear discriminant model (LDA) or a quadratic discriminant model (QDA). In a QDA,

$${g}_{k}^{Q} ( {c}_{i} ) = - \frac{1}{2} {( {c}_{i} - {μ}_{k} )}^{′} {Σ}_{k}^{- 1} ( {c}_{i} - {μ}_{k} ) - \frac{1}{2} log \vert {Σ}_{k} \vert + log ( \frac{{n}_{k}}{n} ) ,$$

where the prime indicates a transpose, while for an LDA, which assumes that the class covariances Σₖ are equal,

$${g}_{k}^{L} ( {c}_{i} ) = {μ}_{k}^{′} {Σ}^{- 1} {c}_{i} - {μ}_{k}^{′} {Σ}^{- 1} {μ}_{k} + log ( \frac{{n}_{k}}{n} ) .$$

According to embodiments, the LDA and QDA models are trained on data acquired from drivers driving in real-world road conditions.

The features, including the individual driver's model, are used by the Bayesian classifier at step 36 to determine a conditional crash probability:

$$P ( {c}_{i} \vert {G}_{i} = k ) = \frac{1}{{( 2 π )}^{1 \text{/} 2} {\vert {Σ}_{k} \vert}^{1 \text{/} 2}} exp ( - \frac{1}{2} {( {c}_{i} - {μ}_{k} )}^{′} {Σ}_{k}^{- 1} ( {c}_{i} - {μ}_{k} ) )$$

which in turn is used to calculate the posterior crash probability at step 37,

$$P ( {G}_{i} = k \vert {c}_{i} ) = \frac{P ( {c}_{i} \vert {G}_{i} = k ) P ( {G}_{i} = k )}{{Σ}_{k} P ( {c}_{i} \vert {G}_{i} = k )} ,$$

and to update each individual model. If the posterior crash probability exceeds a predetermined threshold, at step 38, it is determined that a crash may occur, and a warning may be presented to the driver to take evasive action, or the VCAS itself may take control of the vehicle from the driver to avoid a crash. The updated posterior probability is used as a prior probability in future travels. The posterior probability collected from all drivers' models is also used by the manufacturer to update the original calibration parameters, at step 39.

The vehicle and driver data used includes individual profiles, distance metrics and vehicle dynamics, and behavioral and physiological data. The individual profiles include demographic data, such as gender, age, and education, and driving history, such as driving age, annual distance driven, violation records, and accident records. The distance metrics and vehicle dynamics data includes distance to detected risk (DDR), such as a vehicle in front or a road edge, time to collision (TTC), which equals DDR/relative-velocity, speed, gas-pedal, brake-pedal, and steering-wheel. The gas-pedal and brake-pedal feature values range from 0 for no pressure to 100 for full depth, and the steering-wheel feature value is the angle by which the steering wheel has been turned, also known as the angle of wheeling. The behavioral and physiological data include horizontal fixation, vertical fixation, on-road fixation, skin conductance and heart rate. The fixation features are quantified by the standard deviation of the measurements. Features derived from the distance metrics, vehicle dynamics, and behavioral and physiological data include first and second statistics such as mean values, standard deviations, minimum values and maximum values, and on-road time percentages.

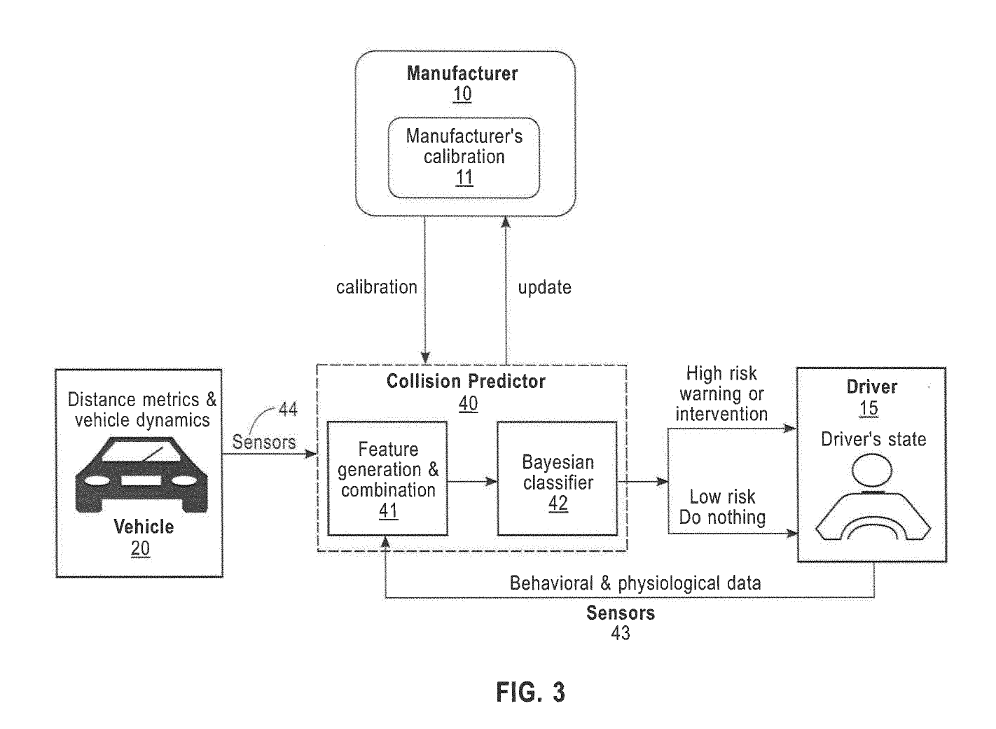

FIG. 3 is a schematic block diagram of a VCAS according to an embodiment of the disclosure. Referring to the figure, a VCAS according to an embodiment includes a collision predictor 40 with a feature generation and combination unit 41 and Bayesian classifier 42. The feature generation and combination unit 41 combines sensor data from sensors 43 on the driver 15 with sensors 44 on the vehicle 20. The driver sensor data includes the behavioral and physiological data described above, and the vehicular sensor data includes the distance metric and vehicle dynamic data disclosed above. The feature generation and combination unit 41 extracts the features from this dataset and provides the features to the Bayesian classifier 42, which, based on the prior probability distribution, determines a risk level for a collision. If the risk is low, the classifier does nothing more, but if the risk is high, i.e., exceeds a predetermined threshold, the classifier 40 issues a visual or audible warning to the driver, or issues commands to a vehicle controller to intervene in the driver's control of the vehicle, such as by taking control of the vehicle from the driver. The prior probability distribution is initialized by the manufacturer 10 based on the manufacturer's calibration 11, and is periodically updated by the classifier 42 as described above, using, for example, a wireless network connection, such as an internet connection.

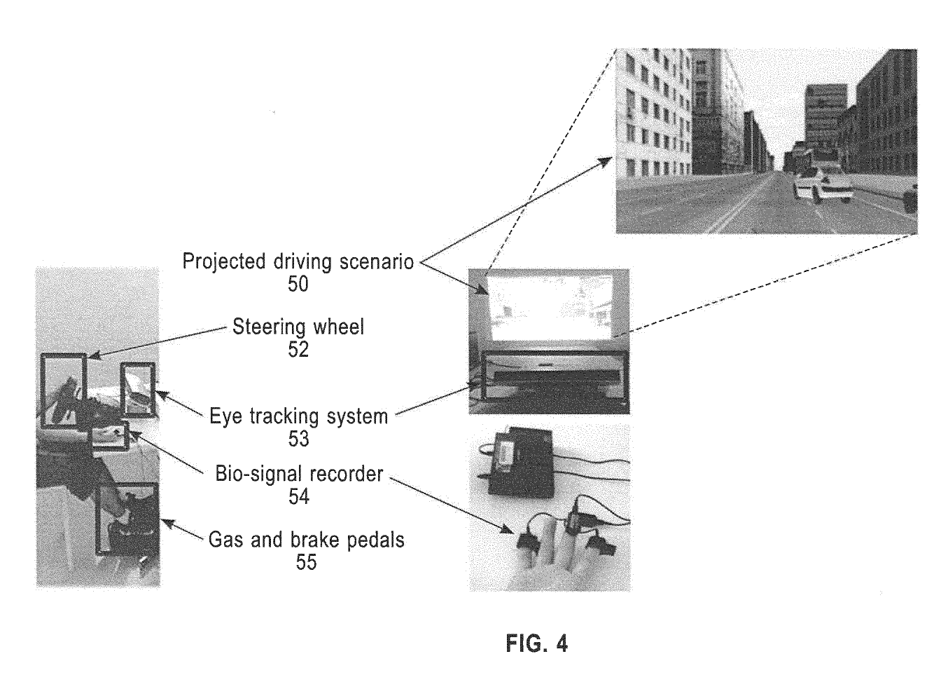

A VCAS according to an embodiment of the disclosure was tested with 184 drivers using driving simulators. A simulator according to an embodiment is shown in FIG. 4 and includes a driving scenario 50 projected onto a computer display monitor 51, a steering wheel 52, an eye tracking system 53, a bio-signal recorder 54, and gas and brake pedals 55. Four different combinations of features were used with two different classifier models. The feature combinations include a first combination that uses individual profiles, distance metrics, vehicle dynamics, and behavior compensation, labeled IVD; a second combination that uses the IVD features, plus skin conductance and heart rate, labeled IVDP; a third combination that uses the IVDP features, plus fixation, labeled IVDF; and a fourth combination that uses all features. The classifier models includes the linear discriminant analysis (LDA) model and the quadratic discriminant analysis (QDA) model. 718 data samples were obtained from the 184 drivers, from 15 seconds to 3 seconds before a predicted crash, including 84 crashes. Performance of the models was evaluated using a K-fold cross validation with K=6, and the accuracy, sensitivity and specificity for all combinations.

$$Accuracy = \frac{True positive + True negative}{Ture positive + False positive + False negative + True negative}$$

$$Sensitivity = \frac{True positive}{Ture positive + False postive} = hit rate$$

$$Specificity = \frac{True negative}{Ture negative + False postive} = 1 - false alarm rate$$

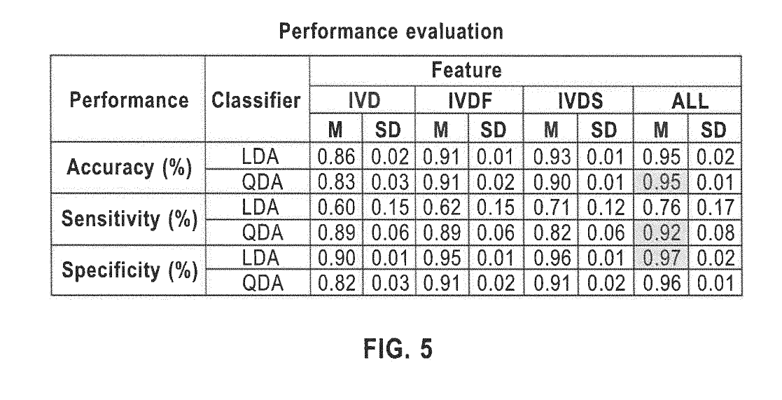

The results are displayed in the table of FIG. 5, in which the mean (M) and standard deviation (SD) of the accuracy, sensitivity and specificity are presented for each combination of features and classifier model. In the case of all features, QDA mean Accuracy result, the QDA mean Sensitivity result, and the LDA mean Specificity results are highlighted as the best results in their respective category. As can be seen from the table, adding more behavioral and physiological features increased the accuracy and specificity, while classifiers with different complexities could have different false positive/false negative ratios.

### System Implementations

It is to be understood that embodiments of the present disclosure can be implemented in various forms of hardware, software, firmware, special purpose processes, or a combination thereof. In one embodiment, an embodiment of the present disclosure can be implemented in software as an application program tangible embodied on a computer readable program storage device. The application program can be uploaded to, and executed by, a machine comprising any suitable architecture. Furthermore, it is understood in advance that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed. An automatic troubleshooting system according to an embodiment of the disclosure is also suitable for a cloud implementation.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

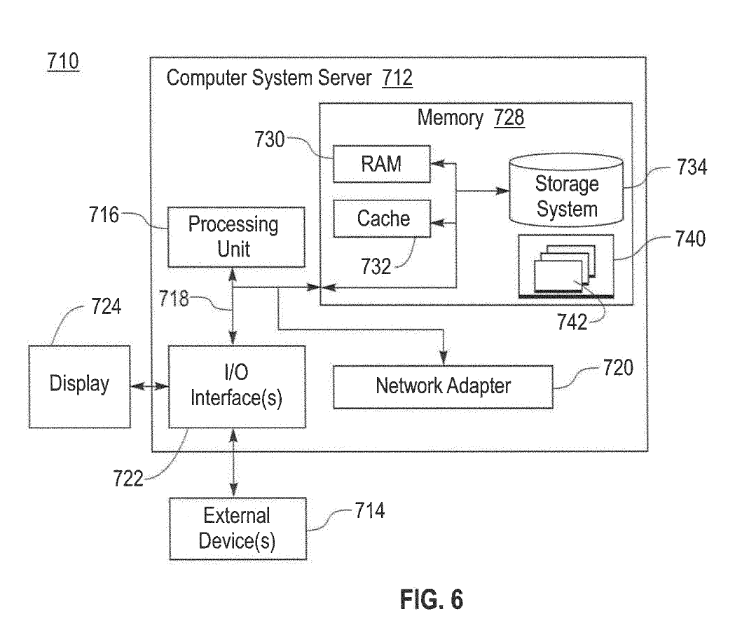

Referring now to FIG. 6, a schematic of an example of a cloud computing node is shown. Cloud computing node 710 is only one example of a suitable cloud computing node and is not intended to suggest any limitation as to the scope of use or functionality of embodiments of the disclosure described herein. Regardless, cloud computing node 710 is capable of being implemented and/or performing any of the functionality set forth hereinabove.

In cloud computing node 710 there is a computer system/server 712, which is operational with numerous other general purpose or special purpose computing system environments or configurations. Examples of well-known computing systems, environments, and/or configurations that may be suitable for use with computer system/server 712 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 712 may be described in the general context of computer system executable instructions, such as program modules, being executed by a computer system. Generally, program modules may include routines, programs, objects, components, logic, data structures, and so on that perform particular tasks or implement particular abstract data types. Computer system/server 712 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 712 in cloud computing node 710 is shown in the form of a general-purpose computing device. The components of computer system/server 712 may include, but are not limited to, one or more processors or processing units 716, a system memory 728, and a bus 718 that couples various system components including system memory 728 to processor 716.

Bus 718 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 712 typically includes a variety of computer system readable media. Such media may be any available media that is accessible by computer system/server 612, and it includes both volatile and non-volatile media, removable and non-removable media.

System memory 728 can include computer system readable media in the form of volatile memory, such as random access memory (RAM) 730 and/or cache memory 732. Computer system/server 712 may further include other removable/non-removable, volatile/non-volatile computer system storage media. By way of example only, storage system 734 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 718 by one or more data media interfaces. As will be further depicted and described below, memory 728 may include at least one program product having a set (e.g., at least one) of program modules that are configured to carry out the functions of embodiments of the disclosure.

Program/utility 740, having a set (at least one) of program modules 742, may be stored in memory 728 by way of example, and not limitation, as well as an operating system, one or more application programs, other program modules, and program data. Each of the operating system, one or more application programs, other program modules, and program data or some combination thereof, may include an implementation of a networking environment. Program modules 742 generally carry out the functions and/or methodologies of embodiments of the disclosure as described herein.

Computer system/server 712 may also communicate with one or more external devices 714 such as a keyboard, a pointing device, a display 724, etc.; one or more devices that enable a user to interact with computer system/server 712; and/or any devices (e.g., network card, modem, etc.) that enable computer system/server 712 to communicate with one or more other computing devices. Such communication can occur via Input/Output (I/O) interfaces 722. Still yet, computer system/server 712 can communicate with one or more networks such as a local area network (LAN), a general wide area network (WAN), and/or a public network (e.g., the Internet) via network adapter 720. As depicted, network adapter 720 communicates with the other components of computer system/server 712 via bus 718. It should be understood that although not shown, other hardware and/or software components could be used in conjunction with computer system/server 712. Examples, include, but are not limited to: microcode, device drivers, redundant processing units, external disk drive arrays, RAID systems, tape drives, and data archival storage systems, etc.

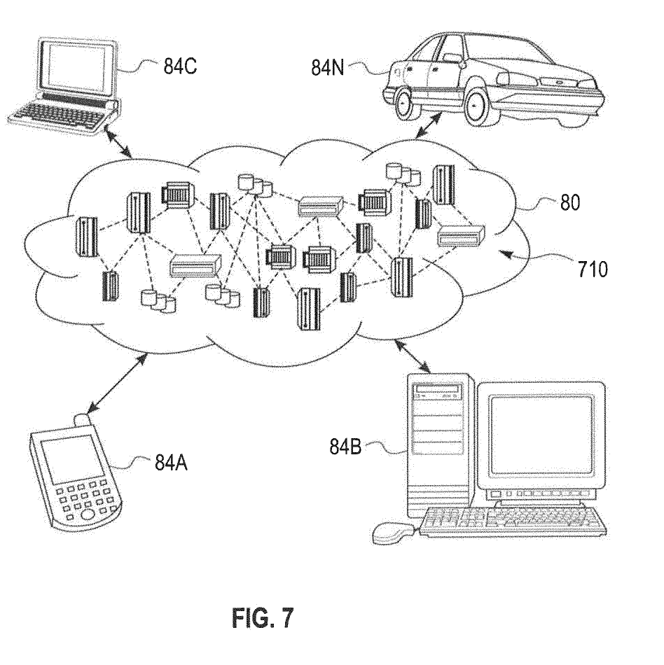

Referring now to FIG. 7, illustrative cloud computing environment 80 is depicted. As shown, cloud computing environment 80 comprises one or more cloud computing nodes 710 with which local computing devices used by cloud consumers, such as, for example, personal digital assistant (PDA) or cellular telephone 84A, desktop computer 84B, laptop computer 84C, and/or automobile computer system 84N may communicate. Nodes 710 may communicate with one another. They may be grouped (not shown) physically or virtually, in one or more networks, such as Private, Community, Public, or Hybrid clouds as described hereinabove, or a combination thereof. This allows cloud computing environment 80 to offer infrastructure, platforms and/or software as services for which a cloud consumer does not need to maintain resources on a local computing device. It is understood that the types of computing devices 84A-N shown in FIG. 7 are intended to be illustrative only and that computing nodes 710 and cloud computing environment 80 can communicate with any type of computerized device over any type of network and/or network addressable connection (e.g., using a web browser).

While embodiments of the present disclosure has been described in detail with reference to exemplary embodiments, those skilled in the art will appreciate that various modifications and substitutions can be made thereto without departing from the spirit and scope of the disclosure as set forth in the appended claims.

What is claimed is:

1. A method for real-time collision avoidance in moving vehicles, comprising the steps of:
initializing a prior collision distribution from a manufacturer's vehicle calibration;
receiving driver data acquired from a driver when a vehicle is driven and vehicular data acquired from the vehicle being driven by the driver,
determining a conditional collision probability using features derived from the driver data and the vehicular data and a model for the driver;
calculating posterior probability collision distribution from the conditional collision probability and the prior collision distribution; and
determining a probability of a collision from the posterior probability collision.

2. The method of claim 1, wherein the driver data and the vehicular data is continuously acquired from the driver and vehicle while the vehicle is in motion.

3. The method of claim 2, wherein the driver data includes one or more of demographic data, driving history data, and behavioral and physiological data.

4. The method of claim 2, wherein the vehicular data includes one or more of distance to detected risk (DDR), time to collision (TTC), speed, gas-pedal, brake-pedal, and steering-wheel.

5. The method of claim 2, wherein features extracted from the driver data and the vehicular data include one or more of mean values, standard deviations, minimum values and maximum values, and on-road time percentages.

6. The method of claim 1, wherein the driver data and the vehicular data is combined into a single dataset synchronized by time of acquisition.

7. The method of claim 1, further comprising, determining that a probability of collision is high, and issuing a warning to the driver or intervening in the driver's operation of the vehicle, in response to said determining that a probability of collision is high.

8. The method of claim 1, further comprising updating the manufacturer's vehicle calibration based on posterior probability collision acquired from all drivers.

9. The method of claim 1, further comprising using principle component analysis to reduce the number of features used to determine the conditional collision probability distribution.

10. A system for real-time collision avoidance in moving vehicles, comprising:
first sensors in a vehicle that acquire behavioral and physiological data from a driver;
second sensors in the vehicle that acquire distance metrics and vehicle dynamics data from a vehicle in motion;
a feature generator and combiner in the vehicle that receives the behavioral and physiological data from the first sensors and the distance metrics and vehicle dynamics data from the second sensors, combines the behavioral and physiological data and distance metrics and vehicle dynamics data into a combined dataset synchronized by acquisition time, and extracts features from the combined dataset;
a classifier in the vehicle that receives features from the feature generator and combiner, uses the features to determine a conditional collision probability distribution, and combines the conditional collision probability distribution with a prior collision probability distribution to calculate the probability of a collision occurring; and
a warning system in the vehicle that presents a visual or audible warning to the driver if a the probability of a collision is determined to exceed a predetermined threshold.

11. The system of claim 10, further comprising a controller that takes control of the vehicle from the driver if a collision is determined to exceed a predetermined threshold.

12. The system of claim 10, wherein the prior collision probability distribution is based on a manufacturer's calibration of the vehicle, the conditional collision probability distribution includes one or more of demographic and driving history data of the driver, and further comprising a wireless network connection that transmits updates for the manufacturer's calibration of the vehicle.

13. A non-transitory program storage device readable by a computer, tangibly embodying a program of instructions executed by the computer to perform the method steps for real-time collision avoidance in moving vehicles, comprising the steps of:
initializing a prior collision distribution from a manufacturer's vehicle calibration;
receiving driver data acquired from a driver when a vehicle is driven and vehicular data acquired from the vehicle being driven by the driver;
determining a conditional collision probability using features derived from the driver data and the vehicular data and a model for the driver;
calculating posterior probability collision distribution from the conditional collision probability and the prior collision distribution; and
determining a probability of a collision from the posterior probability collision.

14. The computer readable program storage device of claim 13, wherein the driver data and the vehicular data is continuously acquired from the driver and vehicle while the vehicle is in motion.

15. The computer readable program storage device of claim 14, wherein the driver data includes one or more of demographic data, driving history data, and behavioral and physiological data.

16. The computer readable program storage device of claim 14, wherein the vehicular data includes one or more of distance to detected risk (DDR), time to collision (TTC), speed, gas-pedal, brake-pedal, and steering-wheel.

17. The computer readable program storage device of claim 14, wherein features extracted from the driver data and the vehicular data include one or more of mean values, standard deviations, minimum values and maximum values, and on-road time percentages.

18. The computer readable program storage device of claim 13, wherein the driver data and the vehicular data is combined into a single dataset synchronized by time of acquisition.

19. The computer readable program storage device of claim 13, the method further comprising, determining that a probability of collision is high, and issuing a warning to the driver or intervening in the driver's operation of the vehicle, in response to said determining that a probability of collision is high.

20. The computer readable program storage device of claim 13, the method further comprising updating the manufacturer's vehicle calibration based on posterior probability collision acquired from all drivers.

21. The computer readable program storage device of claim 13, the method further comprising using principle component analysis to reduce the number of features used to determine the conditional collision probability distribution.
